(19) United States
(12) Patent Application Publication
(10) Pub. No.: US 2012/0236328 A1
(43) Pub. Date: Sep. 20, 2012

(54) PRINT DATA CREATING DEVICE, PRINT DATA CREATING METHOD AND PRINT DATA CREATING PROGRAM

(75) Inventor: Masaru Ohnishi, Nagano (JP)

(73) Assignee: MIMAKI ENGINEERING CO., LTD., NAGANO (JP)

(21) Appl. No.: 13/511,370

(22) PCT Filed: Nov. 26, 2010
(86) PCT No.: PCT/JP2010/071073

§ 371 Date: May 22, 2012

(30) Foreign Application Priority Data
Nov. 26, 2009 (JP) 2009-269061

(51) Int. Cl. G06K 15/02

(52) U.S. Cl. 358/1.2

(57) ABSTRACT

A printer data generating device which is a raster image processor is provided. The raster image processor (RIP) includes, a dot displaced quantity detecting section detecting a displaced quantity of a hitting position of ink, a contour detecting section detecting one pixel corresponding to the contour, a dot size setting section setting a dot size of each pixel to be larger than a resolution pitch based on the displaced quantity detected in the dot displaced quantity detecting section and the pixel corresponding to the contour detected in the contour detecting section.

### TECHNICAL FIELD

The present invention relates to a print data creating device, a print data creating method and a print data creating program for creating print data which form dots on a recording medium with a predetermined resolution pitch by ejecting ink droplets from respective nozzles of an inkjet head.

### BACKGROUND ART

Conventionally, in a high image quality inkjet printer, a multi-pass printing system in which the same scanning line is scanned several times is adopted and thereby the variation of a nozzle characteristic is averaged to enhance image quality.

### CITATION LIST

### Patent Literature

[PTL 1] Japanese Patent Laid-Open No. 2007-008110

### SUMMARY OF INVENTION

### Technical Problem To Be Solved

However, in a high-speed inkjet printer, a one-pass printing system in which the same scanning line is scanned only one time is adopted. Therefore, when variation occurs in the ejection characteristics of nozzles, striped variation may occur in a printed image along a moving direction of the head. Especially, variation of the ejection characteristic relating to the ejecting direction of an ink droplet is the highest cause for the striped variation.

In the Patent Literature 1, a technique is described in which a dot size is capable of being changed. However, in the technique disclosed in Patent Literature 1, a small size dot and a large size dot are selectable to enhance efficiency of image formation. Therefore, even when the technique described in Patent Literature 1 is used, occurrence of the striped variation is not restrained appropriately.

In view of the problem described above, an objective of the present invention is to provide a print data creating device, a print data creating method and a print data creating program which are capable of restraining occurrence of striped variation in a printed image which is printed by an inkjet printer.

### Solution to Problem

A print data creating device in accordance with the present invention is a creating device which creates print data for ejecting ink droplets from each of nozzles of an inkjet head to form dots on a recording medium with a predetermined resolution pitch, and the creating device being provided with a dot size setting section which sets a dot size of the dot to be larger than the resolution pitch.

According to the print data creating device in accordance with the present invention, a dot size of a dot formed on a recording medium is set larger than the resolution pitch to create print data and thus dots formed on the recording medium are overlapped with each other. Therefore, a gap space between adjacent dots is filled and thus, even when the hitting position of an ink droplet is displaced due to variation of an ejection characteristic of a nozzle or the like, occurrence of striped variation is restrained. Further, even when striped variation is occurred during printing, the striped variation can be eliminated by setting the dot size to be larger and thus an exchange rate of the inkjet head is lowered and maintenance cost can be reduced. Further, even in a one-pass printing system or even in a printing system in which printing is performed with fewer passes, a higher image quality in which striped variation is restrained can be attained and thus a high speed operation and a higher image quality can be attained simultaneously. In this case, the setting of the dot size can be, for example, changed by increasing the number of times of ejection of an ink droplet or by increasing an ejecting amount of an ink droplet. Further, the resolution pitch is a distance between centers of adjacent pixels.

In this case, it is preferable that the dot size setting section sets the dot size so that an overlapping width of adjacent dots in a direction perpendicular to a straight line passing through the centers of the adjacent dots becomes two times of the resolution pitch. According to the present invention, even when the hitting position of an ink droplet is displaced by the same quantity as the resolution pitch due to curved flight of an ink droplet or the like, a gap space with a next dot of the adjacent dot can be eliminated.

Further, it is preferable that the dot size setting section sets a diameter of the dot in a range from 2.3 to 3.5 times of the resolution pitch. Also in this case, occurrence of striped variation can be simply and appropriately restrained by eliminating a gap space between adjacent dots in an oblique direction.

Further, it is preferable that the dot size setting section sets the dot size depending on an occurrence rate (degree) of striped variation. When the dot size is set depending on an occurrence rate of striped variation as described above, occurrence of striped variation can be restrained appropriately.

Further, it is preferable that the dot size setting section sets the dot size depending on a displaced quantity of a hitting position of the ink droplet. When the dot size is set depending on a displaced quantity of the hitting position of an ink droplet as described above, a gap space between adjacent dots can be eliminated and occurrence of striped variation is restrained appropriately.

Further, it is preferable that a contour detecting section which detects pixels corresponding to a contour is further provided, and the dot size setting section sets a dot size of the pixel which is detected in the contour detecting section to be smaller than a dot size of other pixels. When the dot size of a pixel corresponding to the contour is set to be smaller as described above, occurrence of striped variation can be restrained while deterioration of the resolution is restrained.

In this case, it is preferable that the dot size setting section sets the dot size of the pixel, which is detected in the contour detecting section, in a range from 1.0 to 2.5 times of the resolution pitch. Also in this case, occurrence of striped variation can be simply and appropriately restrained while deterioration of the resolution is restrained.

Further, it is preferable that an ink density is lowered so that a desired ink density is obtained at a predetermined overlapped area ratio. When the ink density is lowered as described above, even when dots are overlapped with each other, the ink density is restrained from becoming too high.

A print data creating method in accordance with the present invention is a creating method in which print data are created for ejecting ink droplets from each of nozzles of an inkjet head to form dots on a recording medium with a predetermined resolution pitch, and the creating method being provided with a dot size setting step in which a dot size of the dot is set to be larger than the resolution pitch.

According to the print data creating method in accordance with the present invention, a dot size of a dot formed on a recording medium is set to be larger than the resolution pitch to create print data and thus dots formed on the recording medium are overlapped with each other. Therefore, a gap space between adjacent dots is filled and thus, even when the hitting position of an ink droplet is displaced due to variation or the like of an ejection characteristic of a nozzle, occurrence of striped variation is restrained.

A print data creating program in accordance with the present invention is a creating program which creates print data for ejecting ink droplets from each of nozzles of an inkjet head to form dots on a recording medium with a predetermined resolution pitch and the creating program being provided in a computer with a dot size setting step in which a dot size of the dot is set to be larger than the resolution pitch.

According to the print data creating program in accordance with the present invention, a dot size of a dot formed on a recording medium is set to be larger than the resolution pitch to create print data and thus dots formed on the recording medium are overlapped with each other. Therefore, a gap space between adjacent dots is filled and thus, even when the hitting position of an ink droplet is displaced due to variation or the like of an ejection characteristic of a nozzle, occurrence of striped variation is restrained.

### Advantageous Effects of Invention

According to the present invention, striped variation is restrained from being occurred in a printed image which is printed by an inkjet printer.

### BRIEF DESCRIPTION OF DRAWINGS

FIG. 1 is a view showing a structure of an inkjet printer system which includes an “RIP” in accordance with an embodiment of the present invention.

FIG. 2 is a view showing striped variations which are occurred when a hitting position of an ink droplet is displaced.

FIG. 3 is an enlarged view showing a printed pattern in which a dot size is enlarged by one-half power of two (2^{1/2}) times of a resolution pitch.

FIG. 4 is an enlarged view showing a printed pattern in which a dot size is enlarged by two (2) times of a resolution pitch.

FIG. 5 is an enlarged view showing a printed pattern in which a dot size is enlarged by three (3) times of a resolution pitch.

FIG. 6 is a view for calculating a condition in which striped variation is not appeared.

FIG. 7 is a view showing a relationship between a displaced quantity of a hitting position and a radius of a dot in which striped variation is not occurred.

FIG. 8 is an enlarged view showing a printed pattern in which a diameter of a dot is set to be a resolution pitch.

FIG. 9 is an enlarged view showing a printed pattern in which a diameter of a dot is enlarged by three (3) times of a resolution pitch in FIG. 8.

FIG. 10 is an enlarged view showing a printed pattern in which pixels of a contour are deleted and a dot size is enlarged.

FIG. 11 is an enlarged view showing a printed pattern in which pixels other than a contour are deleted and a dot size is enlarged.

FIG. 12 is an enlarged view showing a printed pattern when data of pixels of a contour and data of pixels other than the contour are synthesized.

FIG. 13 is a view showing an ink density curve of a dot with respect to an overlapped area ratio of a dot.

FIG. 14 is a view showing a functional block structure of an RIP.

FIG. 15 is a flow chart showing a processing operation of an RIP.

FIG. 16 is a view for explaining an operation of a line type printer.

### DESCRIPTION OF EMBODIMENTS

A preferred embodiment of a print data creating device, a print data creating method and a print data creating program in accordance with the present invention will be described in detail below with reference to the accompanying drawings. In this embodiment, the present invention is applied to an RIP (Raster Image Processor). In all drawings, the same or corresponding portions are indicated by the same reference signs.

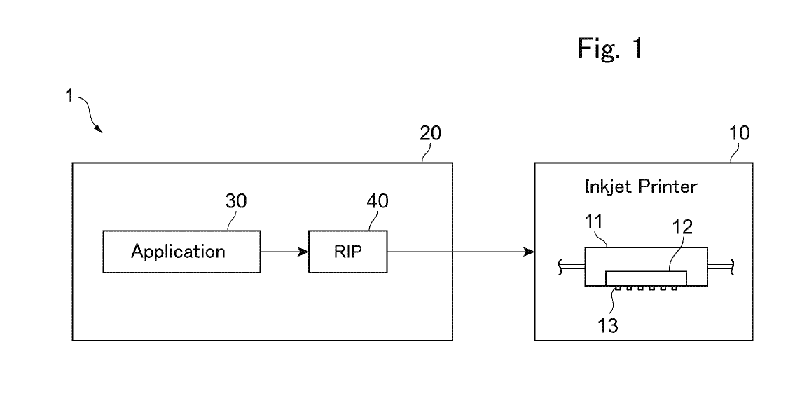

FIG. 1 is a view showing a structure of an inkjet printer system which includes an RIP in accordance with an embodiment of the present invention. As shown in FIG. 1, the inkjet printer system 1 is structured of an inkjet printer 10 and a personal computer 20. An application 30 for preparing image data which are to be printed by the inkjet printer 10 and an RIP 40 which converts the image data into print data which are to be printed by the inkjet printer 10 are incorporated in the personal computer 20.

The inkjet printer 10 is provided with a carriage 11 which is reciprocatedly movable in a scan direction and an inkjet head 12 for ejecting ink droplets is mounted on the carriage 11. The inkjet head 12 is formed with a plurality of nozzles 13 for ejecting ink droplets and a plurality of the nozzles 13 is arranged in a direction perpendicular to the scan direction in which the carriage 11 is moved. Therefore, in this embodiment, the scan direction in which the carriage 11 is moved is referred to as a head moving direction “S”, and a direction in which the nozzles 13 are arranged and which is perpendicular to the head moving direction “S” is referred to as a head nozzle row direction “L”. In the inkjet printer 10, ink droplets are ejected from respective nozzles 13 of the inkjet head 12 while the carriage 11 is reciprocatedly moved in the scan direction to form a plurality of dots on a recording medium.

The “RIP” 40 creates print data in a dot format in order to print in the inkjet printer 10 based on image data such as a dot map format or a JPEG format which are prepared in the application 30. The print data are data for forming dots on a recording medium with a predetermined resolution pitch and are structured of presence/absence of ejection of an ink droplet, the number of times of ejection of an ink droplet, ink droplet amount and the like for each pixel. Further, the RIP 40 sets a dot size of each pixel to be larger than the resolution pitch in order to reduce striped variation occurred in a printed image, calculates the number of times of ejection of an ink droplet and an ejecting amount of an ink droplet so that a dot is formed on a recording medium with the dot size having been set and prepares print data based on the calculated result. In this case, when the number of times of ejection of an ink droplet is increased, a size of a dot formed on a recording medium becomes larger and, when an ejecting amount of an ink droplet is increased, a size of a dot formed on a recording medium becomes larger.

Next, a technique for reducing striped variation by enlarging a dot size will be described in detail below.

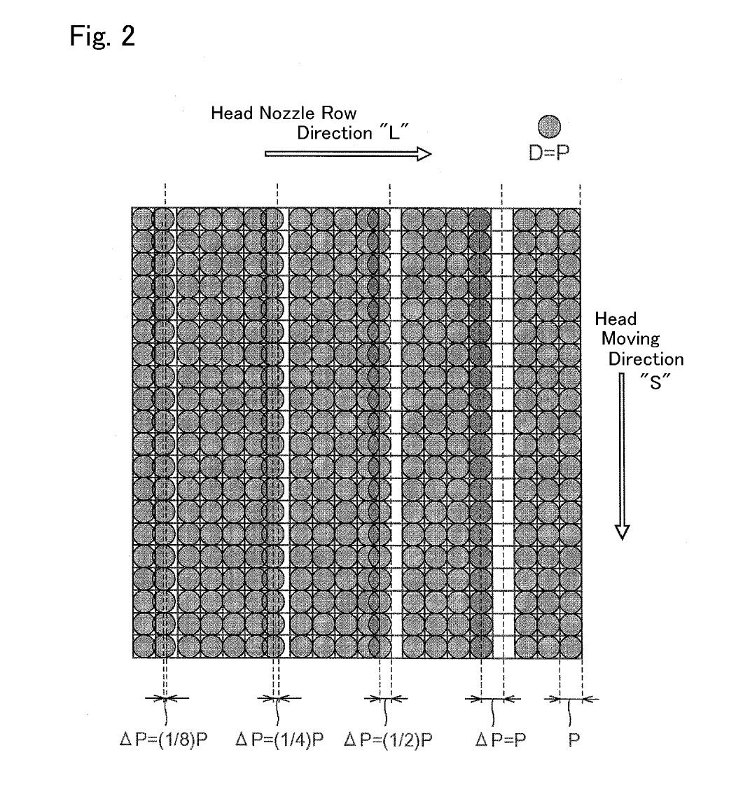

FIG. 2 is a view showing striped variations which are occurred when a hitting position of an ink droplet is displaced. FIG. 2 shows a printed pattern in which a diameter (dot size) “D” of a dot is equal to a resolution pitch “P” and is a view showing a modeled state of striped variations appeared along the head moving direction “S” when an ink droplet ejected from a nozzle 13 is reached at a position displaced by “ΔP” in the head nozzle row direction “L”. The resolution pitch “P” is a distance between centers of adjacent pixels or a width of a pixel. As shown in FIG. 2, when the hitting position of an ink droplet is displaced by ⅛, ¼, ½, 1/1 of the resolution pitch “P”, in other words, when a displaced quantity “ΔP” of a dot is “P/8”, “P/4”, “P/2” and “P”, striped variation is occurred in each of the cases.

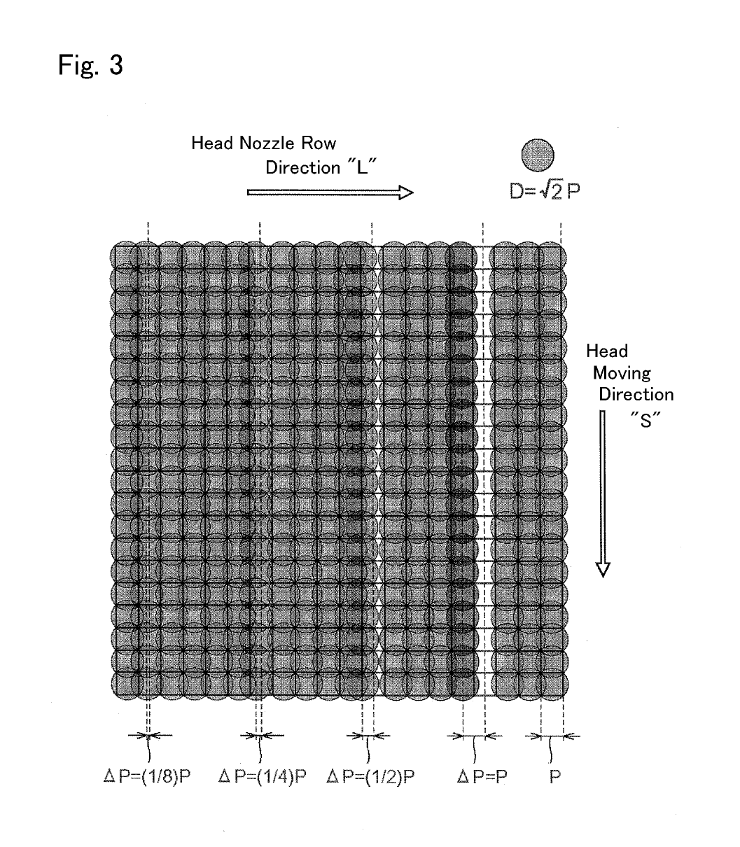

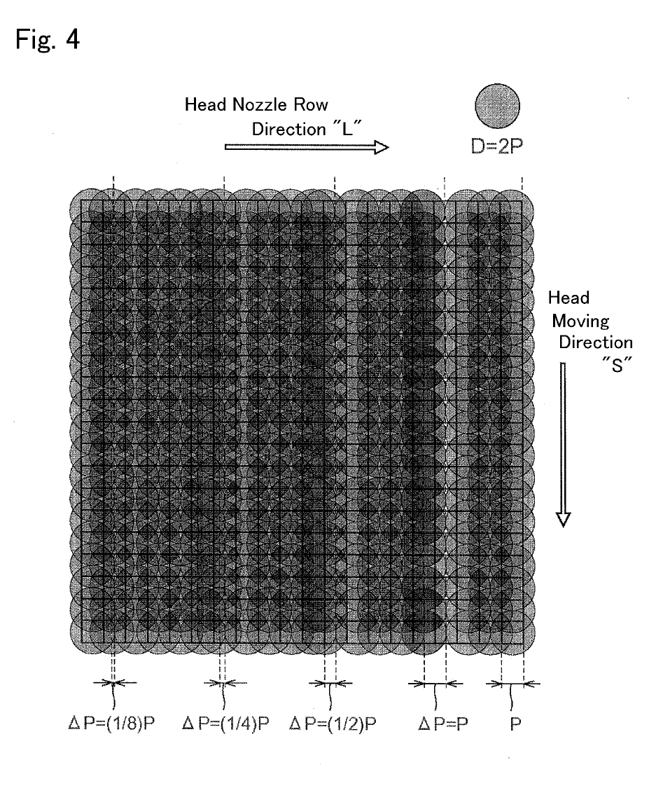

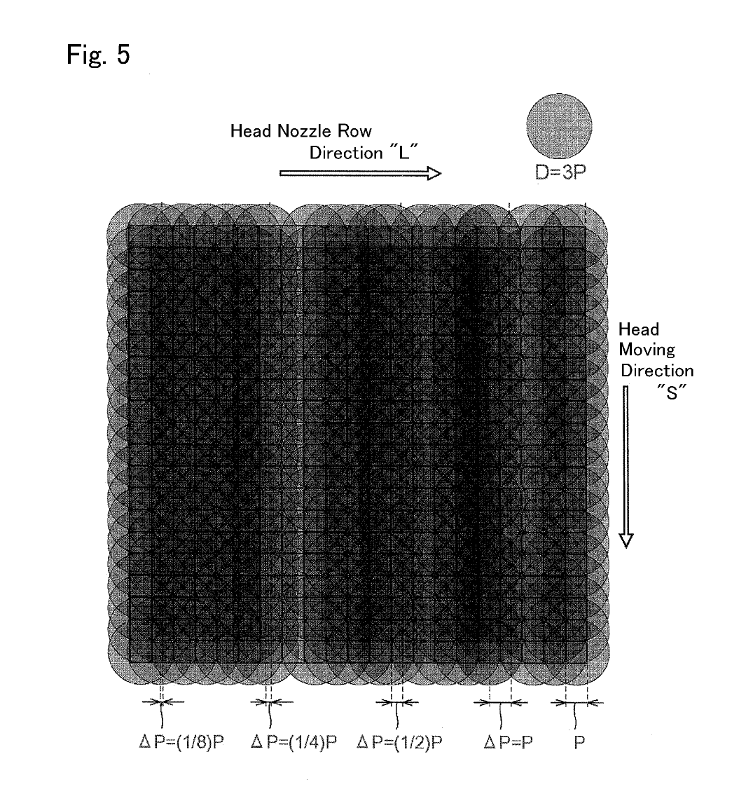

Therefore, when the diameter “D” of a dot is enlarged by one-half power of two (2^{1/2}) times, two (2) times, and three (3) times of the resolution pitch “P”, as shown in FIGS. 3 through 5, the occurrence of striped variations are gradually restrained. FIG. 3 is an enlarged view showing a printed pattern in which a dot size is enlarged by one-half power of two (2^{1/2}) times of the resolution pitch, FIG. 4 is an enlarged view showing a printed pattern in which a dot size is enlarged by two (2) times of the resolution pitch, and FIG. 5 is an enlarged view showing a printed pattern in which a dot size is enlarged by three (3) times of the resolution pitch.

As shown in FIG. 3, when the diameter “D” of a dot is enlarged by 2^{1/2} times (=2 times) of the resolution pitch “P”, a gap space between dots is painted out up to displacement of “ΔP”=“P/8” and the striped variation is eliminated. As shown in FIG. 4, when the size of a dot is enlarged by two (2) times of the resolution pitch, a gap space between dots is painted out further up to displacement of “ΔP”=“P/2” and the striped variation is eliminated. As shown in FIG. 5, when the size of a dot is enlarged by three (3) times of the resolution pitch, a gap space between dots is painted out further up to displacement of “ΔP”=“P” and the striped variation is eliminated. As described above, as the dot size becomes larger, the striped variation becomes to be hardly appeared.

Next, a condition in which striped variation is not appeared for an arbitrary displaced quantity “ΔP” will be described below.

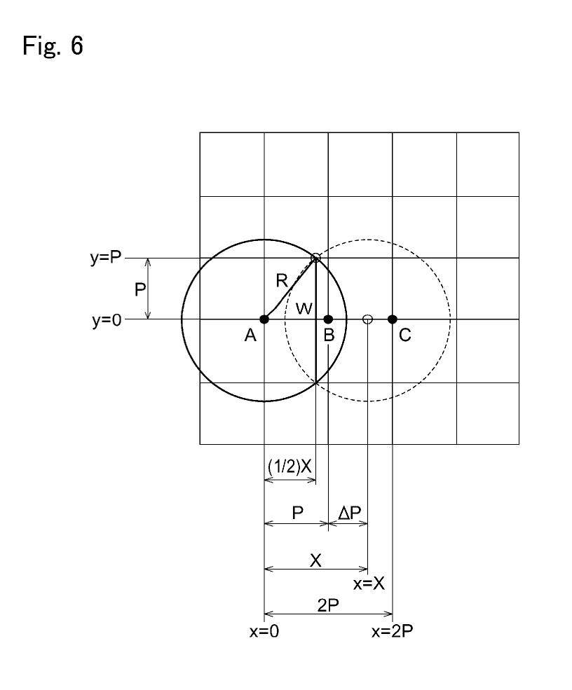

FIG. 6 is a view for calculating a condition in which striped variation is not appeared. In FIG. 6, the point “A”, the point “B” and the point “C” represent a center point of a dot in an ideal state (displaced quantity “ΔP”=0) and the point “A”, the point “B” and the point “C” are arranged in this order on a line. In this case, for convenience, a dot whose center is the point “A” is referred to as the dot “A”, a dot whose center is the point “B” is referred to as the dot “B”, and a dot whose center is the point “C” is referred to as the dot “C”.

As shown in FIG. 6, when a width “W” in which adjacent dots are overlapped with each other in a direction perpendicular to a straight line passing through the centers of the adjacent dots is two (2) times of the resolution pitch “P”, a gap space is completely painted out and striped variation is eliminated. Therefore, when a distance between two adjacent dots is defined as “X” and a radius of a dot is defined as “R”, a condition overlapping with a width of “2P” in a direction perpendicular to a straight line passing through the center (½)X of the adjacent dots is;

{(½)X}²+P²=R² (1)

When the expression (1) is developed, the radius “R” of a dot;

R=[{(½)X}²+P²]^{1/2} (2)

A displaced quantity “ΔP” more than the resolution pitch “P” returns to its initial quantity and thus the condition which does not occur striped variation in “ΔP”=“P” corresponds to a condition which eliminates striped variation for all displaced quantities “ΔP”. Further, even when the dot “B” is displaced by the resolution pitch “P” to be overlapped with the dot “C”, striped variation does not occur in a case that the dot “B” and the dot “C” are connected with the dot “A” and their gap spaces are painted out. Therefore, in order to obtain a condition which does not occur striped variation in the case that “ΔP”=“P”, when “X=2P” is substituted in the expression (2);

R=(P²+P²)=2^{1/2}P≈1.414P (3)

As shown in the expression (3), the condition which does not occur striped variation in the case of “ΔP”=“P” is that the radius “R” of a dot is not less than 1.414“P”.

Further, in order to obtain a condition which does not occur striped variation in the case of “ΔP”=½“P”, when “X=1.5P” is substituted in the expression (2);

R=[{(½)1.5P}²+P²]^{1/2}=1.5625^{1/2}P≈1.25P (4)

As shown in the expression (4), a condition which does not occur striped variation in the case of “ΔP=½P” is that the radius “R” of a dot is not less than 1.25“P” and the diameter “D” of a dot is not less than 2.50“P”.

Further, in order to obtain a condition which does not occur striped variation in the case of “ΔP”=¼“P”, when “X=1.25P” is substituted in the expression (2);

R=[{(½)1.25P}²+P²]^{1/2}=1.39606^{1/2}P≈1.179P (5)

As shown in the expression (5), a condition which does not occur striped variation in the case of “ΔP”=¼“P” is that the radius “R” of a dot is not less than 1.179“P” and the diameter “D” of a dot is not less than 2.358“P”.

Further, in order to obtain a condition which does not occur striped variation in the case of “ΔP”=0 (no displacement), when “X=0” is substituted in the expression (2);

R=[(½)P²+P²]=(1.25)^{1/2}P≈1.18P (6)

As shown in the expression (6), a condition which does not occur striped variation in the case of “ΔP”=0 is that the radius “R” of a dot is not less than 1.18“P” and the diameter “D” of a dot is not less than 2.36“P”.

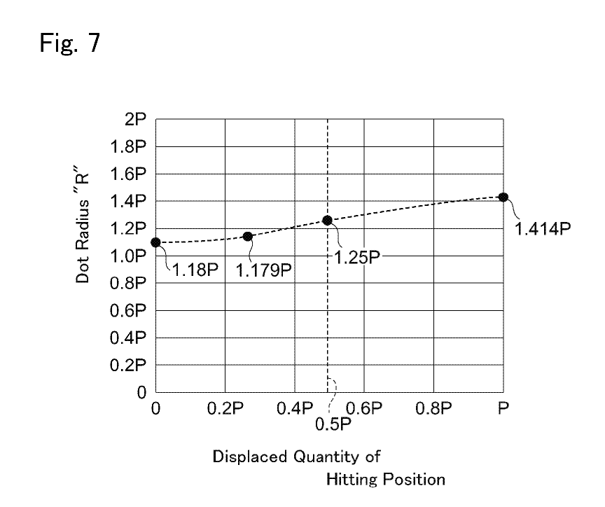

Further, in a case that the “X” is varied from 1.0“P” to 2.0“P”, the radius “R” of a dot calculated by the expression (2) is shown in FIG. 7. FIG. 7 is a view showing a relationship between a displaced quantity of a hitting position and a radius of a dot in which striped variation is not occurred.

As shown in FIG. 7, when the radius “R” of a dot is varied between 1.18“P” and 1.414“P” depending on a displaced quantity of the hitting position, occurrence of a gap space due to displacement of a hitting position of a dot is prevented and thus occurrence of striped variation is prevented. Further, when the diameter “D” of a dot is set to be not less than 2.828“P” (radius “R” is not less than 1.414“P”), occurrence of a gap space due to displacement of a hitting position for all dots is prevented. A dot size is varied with various factors and thus it is preferable that the diameter “D” of a dot is set to be in a range from 2.3“P” to 3.5“P” depending on a displaced quantity of the hitting position.

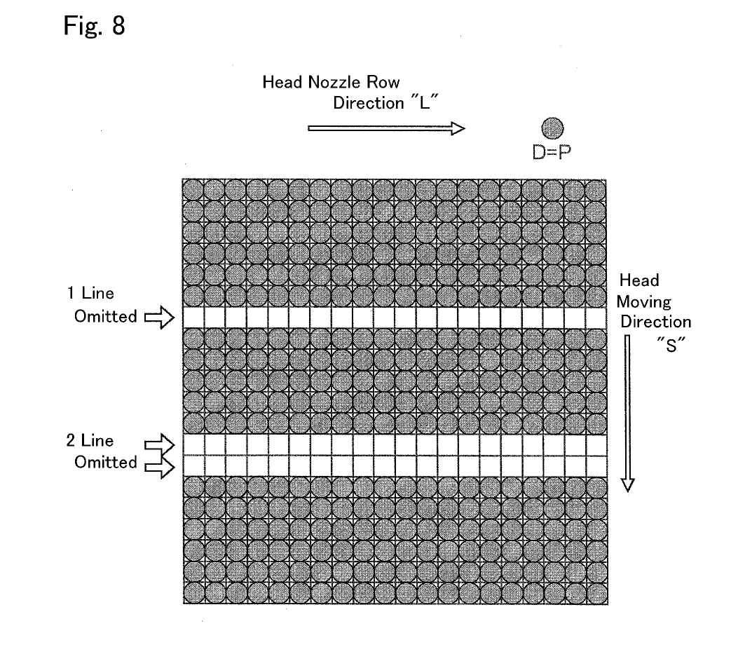

On the other hand, when a dot size is simply increased, the resolution is lowered. FIG. 8 is an enlarged view showing a printed pattern in which a diameter of a dot is set to be a resolution pitch. In FIG. 8, in order to print one blank line and two blank lines, printing is performed along a head nozzle row direction “L” by omitting data for one line and data for two lines. As shown in FIG. 8, in the case of “D”=“P”, the portions where data of one line are omitted are clearly indicated as one omitted line and two omitted lines without being painted out.

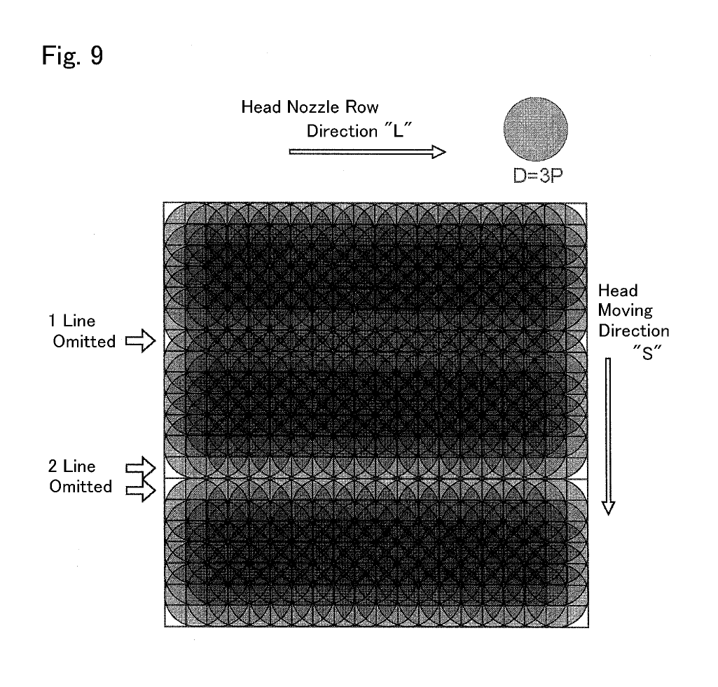

FIG. 9 is an enlarged view showing a printed pattern in which a diameter of a dot is enlarged by three (3) times of the resolution pitch in FIG. 8. As shown in FIG. 9, when it is set that “D”=“3P”, the one blank line is completely painted out to be invisible and the two blank lines are almost painted out to an extent that minute gap space may be visible.

Therefore, pixels corresponding to a contour of an image are detected and a dot size of the pixels corresponding to the contour is set to be smaller than a dot size of the pixels other than the contour and, in this manner, lowering of the resolution is restrained.

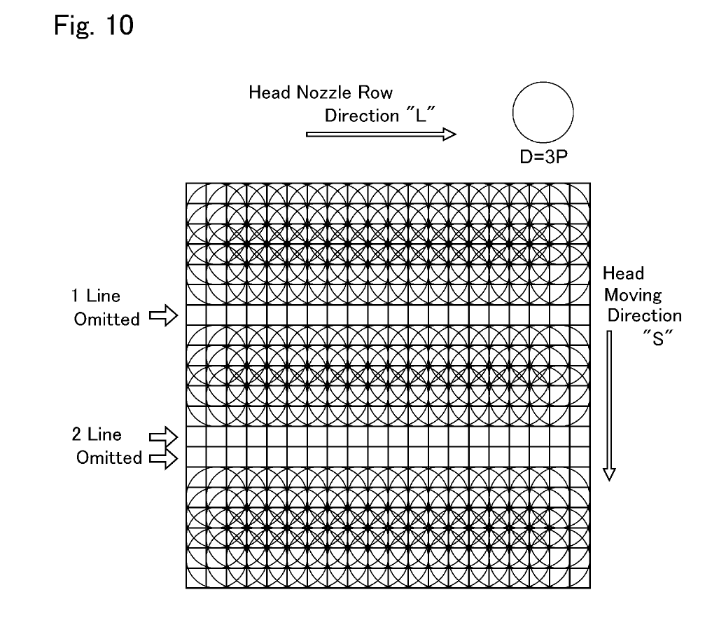

Specifically, first, when pixels corresponding to a contour of an image are detected, one pixel of data corresponding to the contour is erased from original image data and the dot size of the remaining respective pixels is enlarged. The enlargement ratio of the dot size may be, as described above, set that the diameter “D” of a dot is in a range from 2.3 to 3.5 times of the resolution pitch “P”, and it is preferable that the diameter “D” of a dot is set to be not less than 2.828 times of the resolution pitch “P”. FIG. 10 is an enlarged view showing a printed pattern in which pixels of a contour are deleted and a dot size is enlarged. In FIG. 10, as an example, the diameter “D” of a dot is enlarged three (3) times of the resolution pitch “P”. As shown in FIG. 10, in this printed pattern, the dots of pixels other than the contour are overlapped with each other and the gap space is painted out. In this embodiment, the pixel corresponding to the contour is one pixel but, when striped variation does not occur, the pixel corresponding to the contour may be two or more pixels.

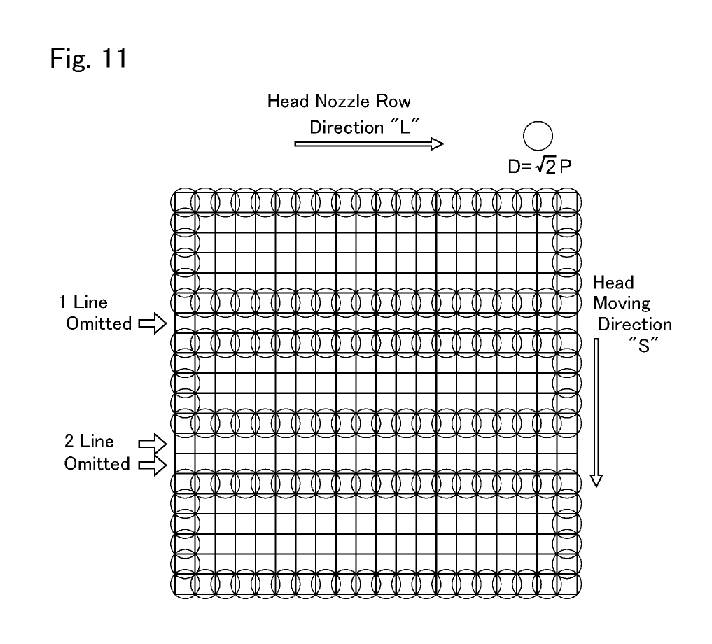

Next, data other than the one pixel corresponding to the contour are erased from the original image data and a dot size of the respective pixels corresponding to the contour is enlarged so as to become smaller than the dot size of the pixels other than those of the contour. The enlargement ratio of the dot size may be set that the diameter “D” of a dot is in a range from 1.0 to 2.5 times of the resolution pitch “P” and it is preferable that the diameter “D” of a dot is set to be in a range from 1.4 to 2.3 times of the resolution pitch “P”. FIG. 11 is an enlarged view showing a printed pattern in which pixels other than the contour are deleted and a dot size is enlarged. In FIG. 11, as an example, the diameter “D” of a dot is enlarged by (2^{1/2}) times of the resolution pitch “P”. As shown in FIG. 11, in this printed pattern, although dots of the pixels corresponding to the contour are enlarged, the enlargement ratio is restrained and thus one omitted blank line and two omitted blank lines are clearly indicated.

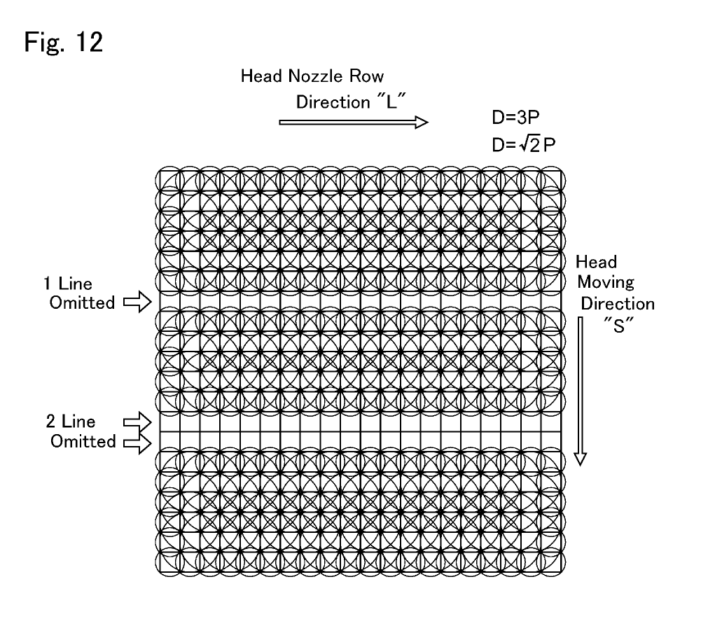

The data of the pixels corresponding to the contour and the data of the pixels other than the contour are synthesized to create print data. FIG. 12 is an enlarged view showing a printed pattern in a case that the data of the pixels of the contour and the data of the pixels other than the contour are synthesized. As shown in FIG. 12, in this printed pattern, the gap space between the dots is painted out and striped variation does not occur and, in addition, the one omitted blank line and the two omitted blank lines are clearly shown without being painted out.

When the dot of a pixel is enlarged as described above, in a portion of a so-called solid coat printing, an overlapping number of times of dots is increased and the print density becomes too high. In this case, the print density can be lowered by simply reducing the ejection dot density per unit area. However, in this technique, the ejection density which can be used is limited on only the low density side and it is conceivable that the tone gradation is lowered.

Therefore, in this embodiment, when dots are overlapped with each other, the ink density of each of the dots is lowered so that the ink density does not become too high.

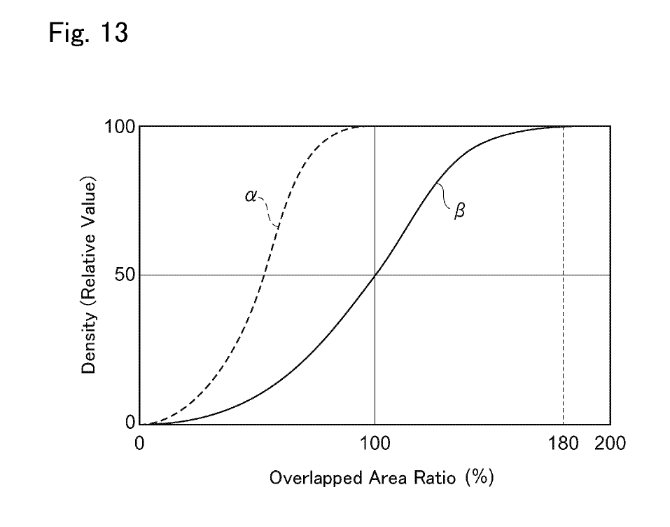

FIG. 13 is a view showing an ink density curve of a dot with respect to an overlapped area ratio of a dot. In FIG. 13, “α” represents a normal ink density curve in which the ink density is not adjusted and “β” represents an ink density curve in which the ink density is adjusted to be low. Further, the overlapped area ratio 100% represents the ink density when solid coat printing with one layer is performed, and the overlapped area ratio 200% represents the ink density when solid coat printing with two layers is performed. Therefore, in a case that dots are not overlapped with each other, the overlapped area ratio is equal to a so-called printing rate.

As shown in FIG. 13, the ink density curve “α” in a case that the ink density is not adjusted is saturated when the overlapped area ratio is 100% and thus, the print density becomes too high when the dots are overlapped with each other. However, when the dot size is enlarged as described above, overlapping of dots is conspicuously occurred and thus, in the ink density curve “α”, the ink density becomes too high due to overlapping of the dots. In order to prevent this problem, in this embodiment, the ink density is set to be saturated when the overlapped area ratio is 180% as shown by the ink density curve “β”. As a result, the saturated density is obtained when the overlapped area ratio of dots becomes 180% and thus half tones can be reproduced in a wider printing rate region. In order to attain compatibility between the half tone and the ink density, it is preferable that a required ink density is obtained when the overlapped area ratio is in a range from 130 to 200%.

Next, functions of the RIP 40 in which the dot size is enlarged by the above-mentioned technique to create print data will be described below.

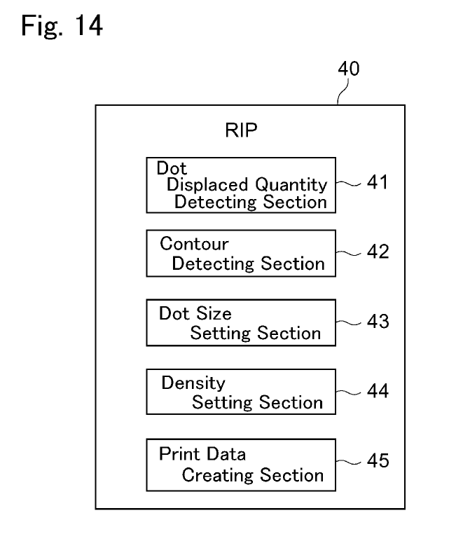

FIG. 14 is a view showing a functional block structure of the RIP. As shown in FIG. 14, the RIP 40 functions as a dot displaced quantity detecting section 41, a contour detecting section 42, a dot size setting section 43, a density setting section 44 and a print data creating section 45. The RIP 40 is, for example, mainly structured of a computer including a CPU, a ROM and a RAM, and computer programs for realizing the respective functions are stored in the ROM and the like. Further, the computer programs are read into the CPU and the RAM and are operated under control of the CPU to realize the respective functions.

The dot displaced quantity detecting section 41 detects a displaced quantity of a hitting position of ink as objective information of striped variation which is occurred on a recording medium. The dot displaced quantity detecting section 41 may detect a displaced quantity of a hitting position by any means. For example, a displaced quantity of a dot may be detected by image-pickuping a recording medium on which a printed pattern is printed with a CCD camera or by detecting an ejection error of the nozzle 13. Alternatively, a displaced quantity of a dot may be detected by a user who observes a recording medium to input the displaced quantity into the RIP 40. Further, the dot displaced quantity detecting section 41 is capable of detecting a displaced quantity of a hitting position at an arbitrary timing and is capable of detecting a displaced quantity of a hitting position before and during printing is performed by the inkjet printer 10.

The contour detecting section 42 detects one pixel corresponding to the contour from image data. As described above, two or more pixels may be detected as the pixel corresponding to the contour unless striped variation does not occur.

The dot size setting section 43 sets a dot size of each of the pixels to be larger than the resolution pitch based on the displaced quantity detected by the dot displaced quantity detecting section 41 and the pixels corresponding to the contour detected by the contour detecting section 42. Specifically, the dot size setting section 43 sets the diameter “D” of a dot of a pixel corresponding to the pixels other than the contour in the range from 2.3 to 3.5 times of the resolution pitch “P” so that the expression (2) is satisfied and a gap space between adjacent dots is painted out, and the diameter “D” of a dot of a pixel corresponding to the contour is set in the range from 1.0 to 2.5 times of the resolution pitch “P”.

The density setting section 44 sets the ink density of a dot thinly based on the ink density curve “β” shown in FIG. 13.

The print data creating section 45 calculates the number of times of ejection, amount of an ink droplet and the like for each pixel based on the dot size of the pixel set in the dot size setting section 43 and the ink density set in the density setting section 44 to create print data by which a dot is formed on a recording medium with a dot size set in the dot size setting section 43.

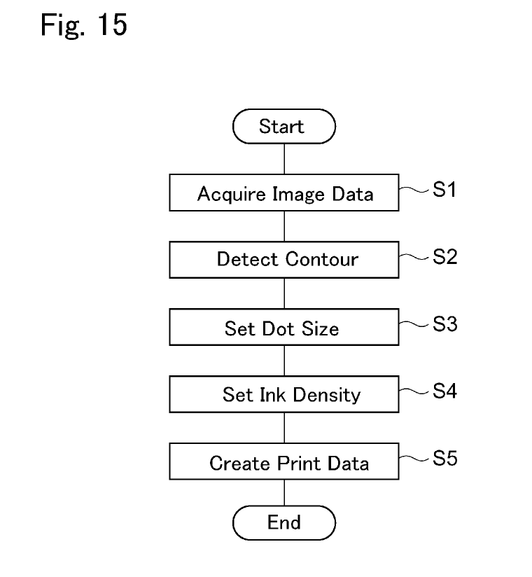

Next, a processing operation of the RIP 40 will be described below with reference to FIG. 15. FIG. 15 is a flow chart showing a processing operation of the RIP. The processing which will be described below is executed in the RIP 40 so that a processing section (not shown) structured of the CPU and the like executes computer programs recorded in a storage device such as a ROM and the following processing is executed.

First, the RIP 40 acquires image data prepared in the application 30 (step S1).

Next, the RIP 40 detects one pixel corresponding to the contour in the contour detecting section 42 (step S2).

Next, the RIP 40 enlarges a dot size of each of the pixels in the dot size setting section 43 (step S3). In other words, the dot size setting section 43 separately sets a diameter size of dots of the pixels corresponding to the contour detected in the step S2 and a dot size of the pixels corresponding to the portion other than the contour.

In other words, the diameter “D” of a dot of a pixel corresponding to the contour is set in the range from 2.3 to 3.5 times of the resolution pitch “P” based on the displaced quantity detected in the dot displaced quantity detecting section 41 so that the expression (2) is satisfied and a gap space between adjacent dots is painted out. The detection of the displaced quantity in the dot displaced quantity detecting section 41 may be performed in advance or may be performed simultaneously in a parallel manner while printing is performed in the inkjet printer 10.

On the other hand, the diameter “D” of a dot of a pixel corresponding to the contour is set in the range from 1.0 to 2.5 times of the resolution pitch “P” so as to be smaller than the diameter “D” of a dot of the pixel corresponding to the portion other than the contour.

Next, the RIP 40 sets the ink density in the density setting section 44 (step S 4). In other words, the density setting section 44 sets the ink density at a lower level so that the overlapped area ratio becomes the saturated density at 180% and a required ink density is obtained when the overlapped area ratio is in the range from 130% to 200% as shown by the ink density curve “β” in FIG. 13.

Next, the RIP 40 creates print data based on the dot size of each pixel enlarged in the step S3 and the ink density set in the step S4 (step S5). After that, the RIP 40 transmits the created print data to the inkjet printer 10 and a series of processing is finished.

As described above, according to this embodiment, the diameter “D” of a dot formed on a recording medium is set to be larger than the resolution pitch “P” to create print data and thus dots formed on the recording medium are overlapped with each other. Therefore, a gap space between adjacent dots is filled and thus, even when the hitting position of an ink droplet is displaced due to variation of an ejection characteristic of the nozzle 13 or the like, occurrence of striped variation is restrained.

Further, even when striped variation is occurred during printing, the striped variation is eliminated by setting the dot size to be larger and thus an exchange rate of the inkjet head is lowered and maintenance cost can be reduced.

Further, even in a one-pass printing system or even in a printing system in which a printing is performed with fewer passes, a higher image quality in which striped variation is restrained can be attained and thus a high speed operation and a higher image quality can be attained simultaneously.

Further, a dot size of a pixel corresponding to the contour is set to be smaller than a dot size of a pixel corresponding to the portion other than the contour and thereby occurrence of the striped variation can be restrained while deterioration of the resolution is restrained.

Further, the ink density is lowered along the ink density curve “β” and thereby, even when dots are overlapped with each other, the ink density is restrained from becoming too high.

Although the present invention has been shown and described with reference to a specific embodiment, the technical scope of the present invention is not limited to the embodiment described above. For example, in the embodiment described above, the dot size setting section 43 automatically enlarges a dot of each pixel based on a displaced quantity which is detected in the dot displaced quantity detecting section 41. However, a dot of each pixel may be enlarged with a predetermined enlargement ratio as a default or a user watches occurrence of striped variation and thereby the enlargement ratio of a dot may be determined appropriately.

Further, in the embodiment described above, the dot size is set within a predetermined range. However, a dot size is capable of being selected in a stepwise manner and a dot size may be selected appropriately based on striped variation, a displaced quantity of the hitting position or the like.

Further, in the embodiment described above, the dot size is set to be two types for a pixel of the contour and for a pixel of a portion other than the contour. However, an arbitrary dot size may be set for an arbitrary pixel to create print data.

Further, in the embodiment described above, the type of the ink which is ejected in the inkjet printer 10 is not specified but, although the present invention is not limited, for example, water-based ink, solvent ink, “UV” ink or the like may be used. Especially, when the present invention is applied to an inkjet printer in which “UV” ink whose dot size is easy to become small is used, a remarkable effect is obtained.

Further, as a technique for setting a dot size (modulation means), for example, a technique in which the number of ink droplets ejected to the same position is increased, a technique in which a voltage applied to an inkjet head is increased, a technique in which ink itself easy to ooze is used may be utilized.

Further, as a technique for representing half tone, for example, a technique in which the number of ejecting ink droplets is changed, a technique in which volume (quantity) of an ink droplet is changed, and a technique in which a size of an ink droplet is changed by a push-and-pull timing control of a piezo element by which a pressure is applied to ink may be utilized. In addition, when variation of an ejection characteristic of a nozzle is small, the size of an ejected ink droplet may be directly changed by an applied voltage.

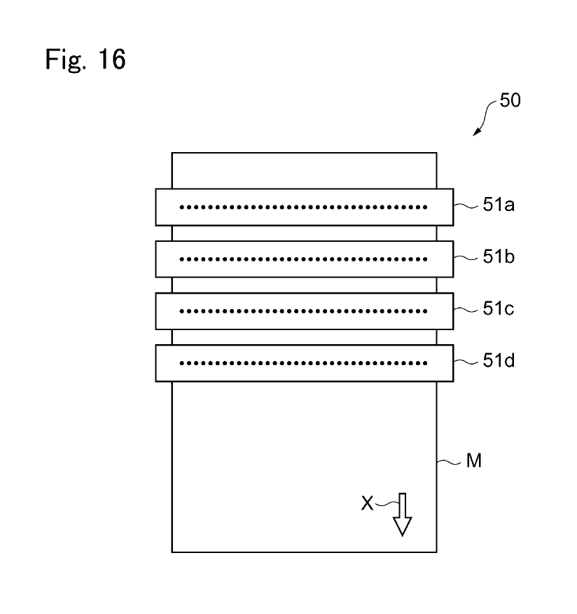

Further, in the embodiment described above, printing is performed by moving the carriage 11 on which the inkjet head 12 is mounted. However, like a line type printer (one-pass printer) and a flat bed type printer, printing may be performed while a recording medium is moved. FIG. 16 is a view for explaining an operation of a line type printer. As shown in FIG. 16, a line type printer performs printing on a recording medium by one scanning (one-pass). In the line type printer 50, line type inkjet heads 51a through 51d for four colors of “Y”, “M”, “C” and “K” are provided, each of the line type inkjet heads 51a through 51d is provided with a width which is required to be printed for a recording medium “M”, or a width of each of the line type inkjet heads 51a through 51d is set to a line width. The colors of the line type inkjet heads are not limited to four colors of “Y”, “M”, “C” and “K” and a required number of colors may be provided. The line type printer 50 ejects ink droplets from the line type inkjet heads 51a through 51d when the recording medium “M” is moved once in the “X” direction which is perpendicular to a direction extending along the line type inkjet heads 51a through 51d and thereby printing is performed on the recording medium. The recording medium “M” may be, for example, a film-like medium or a plate-like medium. Further, the line type printer 50 may be a printer in which only a recording medium “M” is moved or a printer in which a frame on which a recording medium “M” is placed is moved. In this case, the line type inkjet heads 51a through 51d are not moved and relative scanning of the line type inkjet heads 51a through 51d with respect to a recording medium “M” is performed by movement of the line type inkjet heads 51a through 51d.

1. A print data creating device which creates print data for ejecting ink droplets from each of nozzles of an inkjet head to form dots on a recording medium with a predetermined resolution pitch, the print data creating device comprising a dot size setting section which sets a dot size of the dot to be larger than the resolution pitch.

2. The print data creating device according to claim 1, wherein the dot size setting section sets the dot size so that an overlapping width of adjacent dots in a direction perpendicular to a straight line passing through centers of the adjacent dots becomes two times of the resolution pitch.

3. The print data creating device according to claim 1, wherein the dot size setting section sets a diameter of the dot in a range from 2.3 to 3.5 times of the resolution pitch.

4. The print data creating device according to claim 1, wherein the dot size setting section sets the dot size depending on an occurrence degree of striped variation.

5. The print data creating device according to claim 1, wherein the dot size setting section sets the dot size depending on a displaced quantity of a hitting position of the ink droplet.

6. The print data creating device according to one of claim 1, further comprising a contour detecting section which detects pixels corresponding to a contour, wherein the dot size setting section sets a dot size of the pixel which is detected in the contour detecting section to be smaller than a dot size of other pixels.

7. The print data creating device according to claim 6, wherein the dot size setting section sets the dot size of the pixel which is detected in the contour detecting section in a range from 1.0 to 2.5 times of the resolution pitch.

8. The print data creating device according to claim 1, wherein an ink density is lowered so that a desired ink density is obtained at a predetermined overlapped area ratio.

9. A print data creating method in which print data are created for ejecting ink droplets from each of nozzles of an inkjet head to form dots on a recording medium with a predetermined resolution pitch, the print data creating method comprising a dot size setting step in which a dot size of the dot is set to be larger than the resolution pitch.

10. A computer-readable medium stored with a print data creating program which creates print data for ejecting ink droplets from each of nozzles of an inkjet head to form dots on a recording medium with a predetermined resolution pitch, the print data creating program renders being provided in a computer to perform a dot size setting step in which a dot size of the dot is set to be larger than the resolution pitch.
